(19) United States
(12) Patent Application Publication
(10) Pub. No.: US 2015/0196057 A1
(43) Pub. Date: Jul. 16, 2015

(54) ELECTRONIC ATOMIZATION DEVICE

(71) Applicant: SHENZHEN JIESHIBO TECHNOLOGY CO., LTD., Shenzhen, Guangdong (CN)

(72) Inventor: Jianyong Wu, Shenzhen (CN)

(73) Assignee: SHENZHEN JIESHIBO TECHNOLOGY CO., LTD., Shenzhen, Guangdong (CN)

(21) Appl. No.: 14/413,012

(22) PCT Filed: Jan. 14, 2014
(86) PCT No.: PCT/CN2014/070583

§ 371 Date: Jan. 6, 2015

(51) Int. Cl. A24F 47/00; G07C 9/00; G06K 9/00; G10L 17/00; G06F 3/041; G06F 3/02

(52) U.S. Cl. CPC A24F 47/008; G06F 3/041; G06F 3/02; G06K 9/00087; G06K 9/00288; G06K 9/00617; G10L 17/005; G07C 9/00158

(57) ABSTRACT

Disclosed is an electronic atomization device, which includes a housing, an atomizer for storing flavor materials and making the flavor materials be atomized and a power supply. Both of the power supply and the atomizer are disposed in the housing. The device further includes an main control circuit disposed in the housing and an authentication device for receiving and identifying authentication information entered by user, the main control circuit is electrically connected with the power supply and atomizer so as to control the power supply whether to supply power to the atomizer or not, and the authentication device is electrically connected with the main control circuit so as to transmit the authentication information to the main control circuit for identification of user permission. As disclosed in the present invention, it can prevent the electronic atomization device from being used by other people without authorization, thereby protecting the minors effectively.

### FIELD OF THE INVENTION

The present invention relates to smoking equipment and, in particular, it concerns an electronic atomization device.

### BACKGROUND OF THE INVENTION

Electronic atomization device, also called electronic cigarette, atomization tobacco with low temperature, is mainly used for reducing harm brought by smoking traditional cigarette. Its appearance and taste are similar to cigarette and it has more flavors than even normal cigarette does. It can also create a cloud, a taste and a feel that resemble cigarette. The electronic atomization device, which is composed of battery assembly and atomizer, is an imitative cigarette, and flavor components therein can be atomized into gas by atomization so that user can inhale it directly. The flavor materials include tobacco liquid, tobacco shred, tobacco powder, tobacco paste, fragrant slice, fragrant bar, liquid tobacco and so on.

Generally, electronic atomization device does not have a function of preventing from being used by other people except the user itself, thus, it is easy to be used by some minors around the user, which brings an adverse effect on body and thought of the minors.

### SUMMARY OF THE INVENTION

An object of the present invention is to overcome the defects of the prior art by providing an electronic atomization device, so as to prevent the electronic atomization device from being used by other people without authorization.

To achieve the above object, there are provided following technical solutions:

There is provided an electronic atomization device, including a housing, an atomizer for storing flavor materials and making the flavor materials be atomized and a power supply, both of the power supply and the atomizer are disposed in the housing. The electronic atomization device further includes an main control circuit disposed in the housing and an authentication device for receiving and identifying authentication information entered by user, the main control circuit is electrically connected with the power supply and atomizer so as to control the power supply whether to supply power to the atomizer or not, and the authentication device is electrically connected with the main control circuit so as to transmit the authentication information to the main control circuit for identification of user permission.

In a preferred embodiment, the authentication device includes an input unit for inputting a password as the authentication information and a storage unit, the input unit is electrically connected with the main control circuit so as to transmit the password entered by the user to the main control circuit, and the storage unit is electrically connected with the main control circuit so as to store the password for being called by the main control unit.

Preferably, the input unit includes a numeric keyboard disposed on the housing and a keyboard circuit for detecting an input of the numeric keyboard, and the keyboard circuit is electrically connected with the main control circuit so as to transmit the authentication information, entered by the user via the numeric keyboard, to the main control circuit.

Preferably, the input unit further includes a display screen for outputting a prompt message, and the display screen is disposed on the housing and electrically connected with the main control circuit.

Preferably, the input unit includes a touch screen disposed on the housing, and the touch screen is electrically connected with the main control circuit for transmitting the authentication information, entered by the user via the touch screen, to the main control circuit.

In a preferred embodiment, the authentication device includes a fingerprint reader and a storage unit, the fingerprint reader includes a fingerprint collecting unit disposed on the housing and a fingerprint identification circuit for identifying a fingerprint collected by the fingerprint collecting unit and then generating a fingerprint information, the fingerprint identification circuit is electrically connected with the main control circuit so as to transmit the fingerprint information to the main control circuit, and the storage unit is connected with the main control circuit so as to store the fingerprint information of the user.

In a preferred embodiment, the authentication device includes a face recognition unit and a storage unit, the face recognition unit including a camera disposed on the housing and a face identification circuit for identifying a face image collected by the camera and then generating a face recognition information, the face identification circuit is electrically connected with the main control circuit so as to transmit the face recognition information to the main control circuit, and the storage unit is connected with the main control circuit so as to store the face recognition information of the user.

In a preferred embodiment, the authentication device includes an iris recognition unit and a storage unit, the iris recognition unit including an iris scanner disposed on the housing and an iris identification circuit for identifying an iris image collected by the iris scanner and then generating an iris recognition information, the iris identification circuit is electrically connected with the main control circuit so as to transmit the iris recognition information to the main control circuit, and the storage unit is connected with the main control circuit so as to store the iris recognition information of the user.

In a preferred embodiment, the authentication device includes a voice recognition unit and a storage unit, the voice recognition unit including a microphone disposed on the housing and a voice processing circuit for identifying a voice signal collected by the microphone and then generating a voice recognition information, the voice processing circuit is electrically connected with the main control circuit so as to transmit the voice recognition information to the main control circuit and the storage unit is connected with the main control circuit so as to store the voice recognition information of the user.

Preferably, the authentication device further includes a switch button electrically connected with the main control circuit for controlling a start or an end of an authentication process.

Preferably, the authentication device further includes an indicator light used as an indication of a state of charge, a state of authentication and a state of use, and the indicator light is connected with and controlled by the main control circuit.

Preferably, the authentication device further includes a buzzer disposed in the housing and electrically connected with the main control circuit for giving a warning when failing to authenticate the user.

Preferably, further includes a network module, which is electrically connected with the main control circuit for building a communication between the electronic atomization device and a network server via network.

Preferably, further includes a USB interface, which is connected with the main control circuit for charging and transmission of data.

Compared with the prior art, the present invention has beneficial effects as follows:

As disclosed in the present invention, an authentication device is added into the electronic atomization device of the present invention. When using the electronic atomization device for the first time, the user can enter authentication information as original authentication information and then only when the authentication information entered by the user is consistent with the original authentication information can the electronic atomization device be used, in the subsequent actions. Thus, it can prevent the electronic atomization device from being used by other people without authorization, thereby protecting the minors effectively. The authentication device can be implemented in several different ways, such as password, fingerprint recognition, face recognition, iris recognition or voice recognition and so on, which will cause difference costs and conveniences.

### BRIEF DESCRIPTION OF THE DRAWINGS

FIG. 1 is a front view of an electronic atomization device according to a first embodiment of the present invention;

FIG. 2 is a section view of the electronic atomization device according to the first embodiment of the present invention;

FIG. 3 a front view of an electronic atomization device according to a second embodiment of the present invention;

FIG. 4 a section view of the electronic atomization device according to the second embodiment of the present invention;

FIG. 5 is a front view of an electronic atomization device according to a third embodiment of the present invention;

FIG. 6 is a section view of the electronic atomization device according to the third embodiment of the present invention;

FIG. 7 is a front view of an electronic atomization device according to a fourth embodiment of the present invention;

FIG. 8 is a section view of the electronic atomization device according to the fourth embodiment of the present invention;

FIG. 9 is a front view of an electronic atomization device according to a fifth embodiment of the present invention;

FIG. 10 is a section view of the electronic atomization device according to the fifth embodiment of the present invention;

FIG. 11 is a front view of an electronic atomization device according to a sixth embodiment of the present invention; and

FIG. 12 is a section view of the electronic atomization device according to the sixth embodiment of the present invention.

### DETAILED DESCRIPTION OF ILLUSTRATED EMBODIMENTS

For understanding the technical content of the present invention more sufficiently, now combine specific embodiments to introduce and illustrate the technical solution of the present invention as follows.

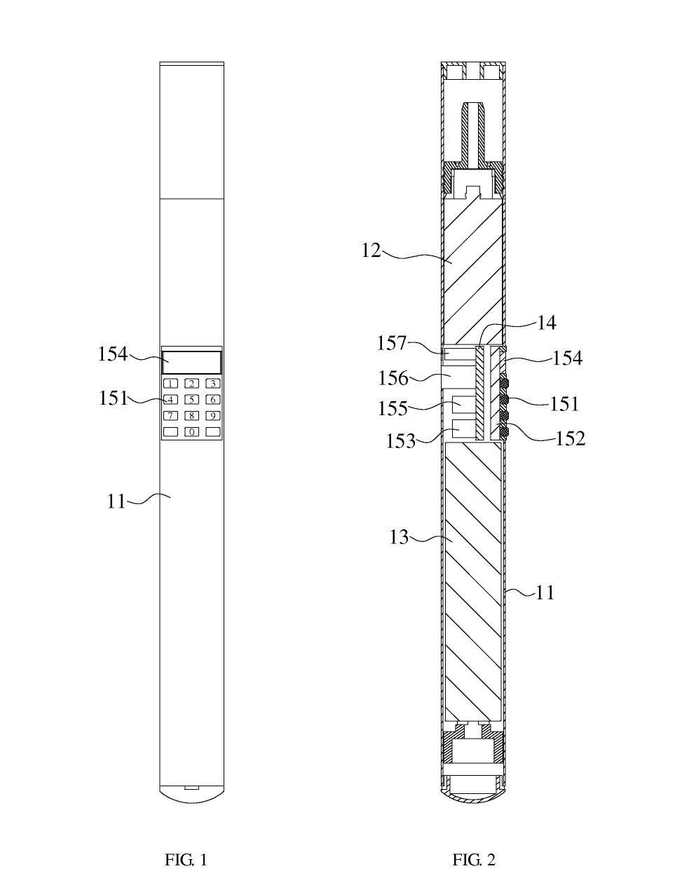

FIG. 1 and FIG. 2 illustrate a detailed structure of the electronic atomization device according to a first embodiment of the present invention.

The electronic atomization device according to the first embodiment includes a housing 11, an atomizer 12 containing tobacco sauce, a power supply 13, a main control circuit 14 and a authentication device for receiving and identifying authentication information entered by user. The power supply 13, the main control circuit 14 and the atomizer 12 are all disposed in the housing 11. The main control circuit 14 is electrically connected with the power supply 13 and the atomizer 12 so as to control the power supply 13 whether to supply power to the atomizer 12 or not. The authentication device is electrically connected with the main control circuit 14 so as to transmit the authentication information entered by the user to the main control circuit 14 for identification of user permission.

According to the first embodiment, the authentication device is provided with a function of password verification. The authentication device includes an input unit for inputting a password as the authentication information and a storage unit 153. The input unit is electrically connected with the main control circuit 14 so as to transmit the authentication information of password entered by the user to the main control circuit 14. The input unit includes a numeric keyboard 151 and a display screen 154, both of which are disposed on the housing 11, and further includes a keyboard circuit 152 for detecting an input of the numeric keyboard 151. The numeric keyboard 151 includes ten number keys from 0 to 9, and may include a “clear” key and a “confirm” key. The keyboard circuit 152 is electrically connected with the main control circuit 14 so as to transmit the authentication information of password, entered by the user via the numeric keyboard 151, to the main control circuit 14. The storage unit 153 is electrically connected with the main control circuit 14 so as to store the password for being called by the main control unit 14. The display screen 154 is disposed on the housing 11 and electrically connected with the main control circuit 14 for outputting various prompt messages. According to this embodiment, all the prompt messages can be displayed by the display screen 154, thus an indicator light is not needed.

The electronic atomization device further includes a network module 155, a buzzer 157 disposed in the housing 14 and a USB interface 156. The buzzer 157 is electrically connected with the main control circuit 14 for giving a warning when failing to authenticate the user. The USB interface 156 is connected with the main control circuit 14 for charging and transmission of data. The USB interface 156 is a mini USB interface.

The network module 155 is electrically connected with the main control circuit 14 for building a communication between the electronic atomization device and a network server via network. The network module 155 may be a wireless network card IC so as to connect the electronic atomization device to the network directly; and the network module 155 may be a Bluetooth IC so that the electronic atomization device can connect to the network via a peripheral equipment such as portable computer. In other embodiments, the network modules 155 also may be other wireless IC, such as Zigbee IC and so on. Due to the network module 155, the electronic atomization device can connect to the network so as to achieve a registration when the electronic atomization device is used for the first time, to store the authentication information of user into the network server as a backup and to record the number and frequency of the electronic atomization device used by the user thereby giving the user some suitable health warnings.

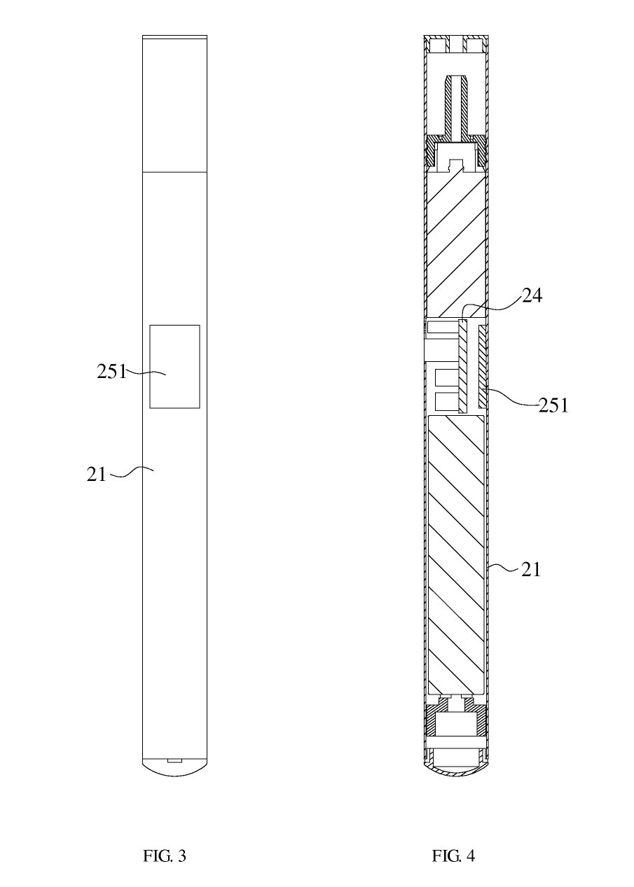

FIG. 3 and FIG. 4 illustrate a detailed structure of the electronic atomization device according to a second embodiment of the present invention. The difference between the second embodiment and the first embodiment is the input unit.

According to the second embodiment, the input unit includes a touch screen 251 disposed on the housing 21. The touch screen 251 is electrically connected with the main control circuit 24 for transmitting the authentication information of password, which is entered by the user via the touch screen 251, to the main control circuit 24. The touch screen 251 is a capacitive touch screen. The touch screen shows ten number keys from 0 to 9, and may include a “clear” key and a “confirm” key. The touch screen 251 is also used for displaying prompt messages.

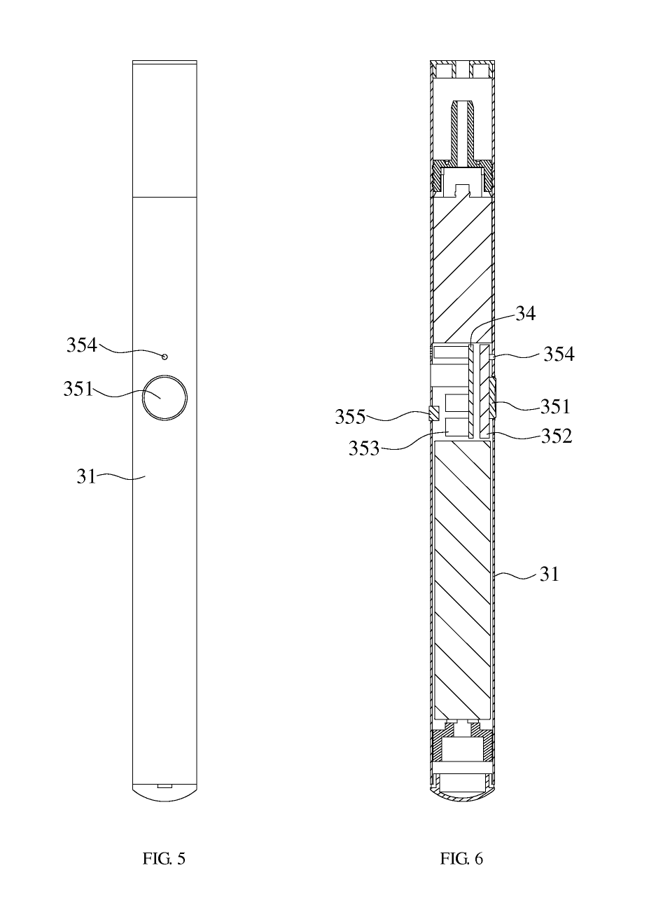

FIG. 5 and FIG. 6 illustrate a detailed structure of the electronic atomization device according to a third embodiment of the present invention. The difference between the third embodiment and the first embodiment is authentication device.

The authentication device includes a fingerprint reader and a storage unit 353. The fingerprint reader includes a fingerprint collecting unit 351 disposed on the housing 31 and a fingerprint identification circuit 352 for identifying fingerprints collected by the fingerprint collecting unit 351 and generating fingerprint information. The fingerprint identification circuit 352 is electrically connected with the main control circuit 34 so as to transmit the fingerprint information to the main control circuit 34, and the storage unit 353 is connected with the main control circuit 34 so as to store the fingerprint information of the user. An authentication process can be achieved by the fingerprint reader in two ways: one is a regular usage that it needs to carry out an authentication process only once by pressing a finger against the fingerprint collecting unit 351 at the beginning of using the electronic atomization device; the other one is that it needs to carry out an authentication process by pressing a finger against the fingerprint collecting unit 351 every time the user inhales a puff of smoke from the electronic atomization device during using the electronic atomization device.

The authentication device further includes a switch button 355 and an indicator light 354, both of which are disposed on the housing 31. The switch button 355 is electrically connected with the main control circuit 34 for controlling a start or an end of the authentication process. The switch button 355 is disposed at the back of the fingerprint collecting unit 351. The main control circuit 34 is electrically connected with the indicator light 354 so as to control the indicator light 354. The indicator light 354 is disposed right above the fingerprint collecting unit 351. The indicator light 354 is used as an indication of a state of charge, a state of authentication and a state of use by providing different colors and different flash frequency of light.

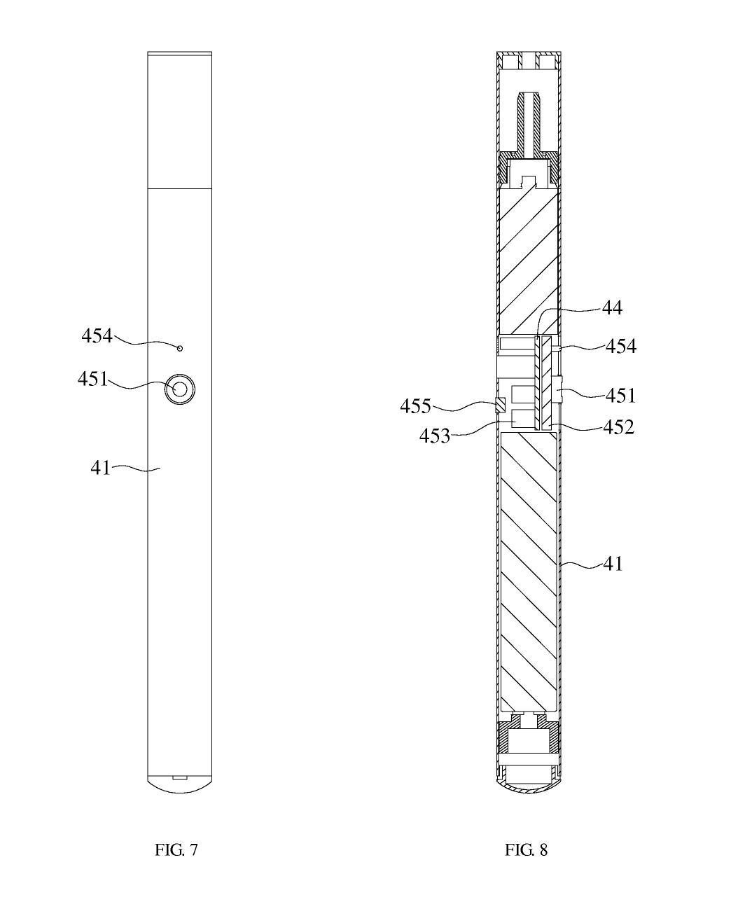

FIG. 7 and FIG. 8 illustrate a detailed structure of the electronic atomization device according to a fourth embodiment of the present invention. The difference between the fourth embodiment and the first embodiment is the authentication device.

The authentication device includes a face recognition unit and a storage unit 453. The face recognition unit includes a camera 451 disposed on the housing 41 and a face identification circuit 452 for identifying face image collected by the camera 451 and generating face recognition information. The face identification circuit 452 is electrically connected with the main control circuit 44 so as to transmit the face recognition information to the main control circuit 44, and the storage unit 453 is connected with the main control circuit 44 so as to store the face recognition information of the user.

According to the fourth embodiment, the camera 451 is disposed at the side of the housing 41. In other embodiments, the camera 451 may be disposed at the top of the housing 41 and the camera 451 faces toward a direction which is parallel to the axial direction of the electronic cigarette. Before using the electronic atomization device, if an authentication process is needed, it can be carried out by aiming the axis of the electronic cigarette onto the face of user for convenience to carry out face recognition.

The authentication device further includes a switch button 455 and an indicator light 454, both of which are disposed on the housing 41. The switch button 455 is electrically connected with the main control circuit 44 for controlling a start or an end of the authentication process. The switch button 455 is disposed at the back of the camera 451. The main control circuit 44 is electrically connected with the indicator light 454 so as to control the indicator light 454. The indicator light 454 is disposed right above the camera 451. The indicator light 454 is used as an indication of a state of charge, a state of authentication and a state of use by providing different colors and different flash frequency of light.

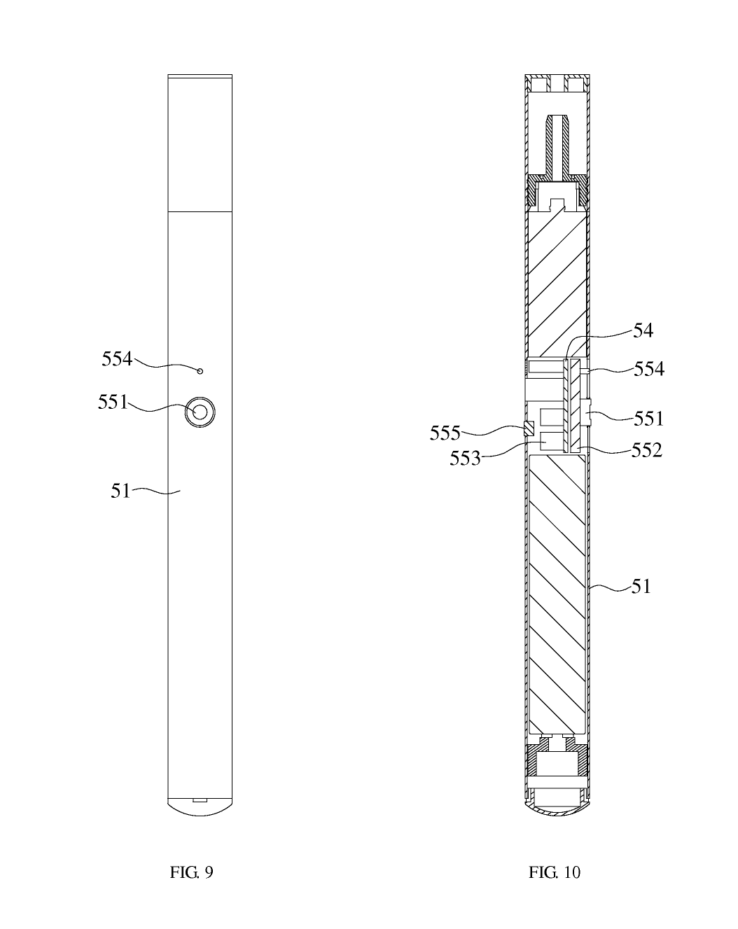

FIG. 9 and FIG. 10 illustrate a detailed structure of the electronic atomization device according to a fifth embodiment of the present invention. The difference between the fifth embodiment and the first embodiment is the authentication device.

The authentication device further includes an iris recognition unit and a storage unit 553. The iris recognition unit includes an iris scanner 551 disposed on the housing 51 and an iris identification circuit 552 for identifying iris image collected by the iris scanner 551 and generating iris recognition information. The iris identification circuit 552 is electrically connected with the main control circuit 54 so as to transmit the iris recognition information to the main control circuit 54. The storage unit 553 is connected with the main control circuit 54 so as to store the iris recognition information of the user.

According to the fifth embodiment, the iris scanner 551 is disposed at the side of the housing 51. In other embodiments, the iris scanner 551 may be disposed at the top of the housing 51 and the iris scanner 551 faces toward a direction which is parallel to the axial direction of the electronic cigarette so that it is convenient to carry out an authentication process.

The authentication device further includes a switch button 555 and an indicator light 554, both of which are disposed on the housing 51. The switch button 555 is electrically connected with the main control circuit 54 for controlling a start or an end of the authentication process. The switch button 555 is disposed at the back of the iris scanner 551. The main control circuit 54 is electrically connected with the indicator light 554 so as to control the indicator light 554. The indicator light 554 is disposed right above the iris scanner 551. The indicator light 554 is used as an indication of a state of charge, a state of authentication and a state of use by providing different colors and different flash frequency of light.

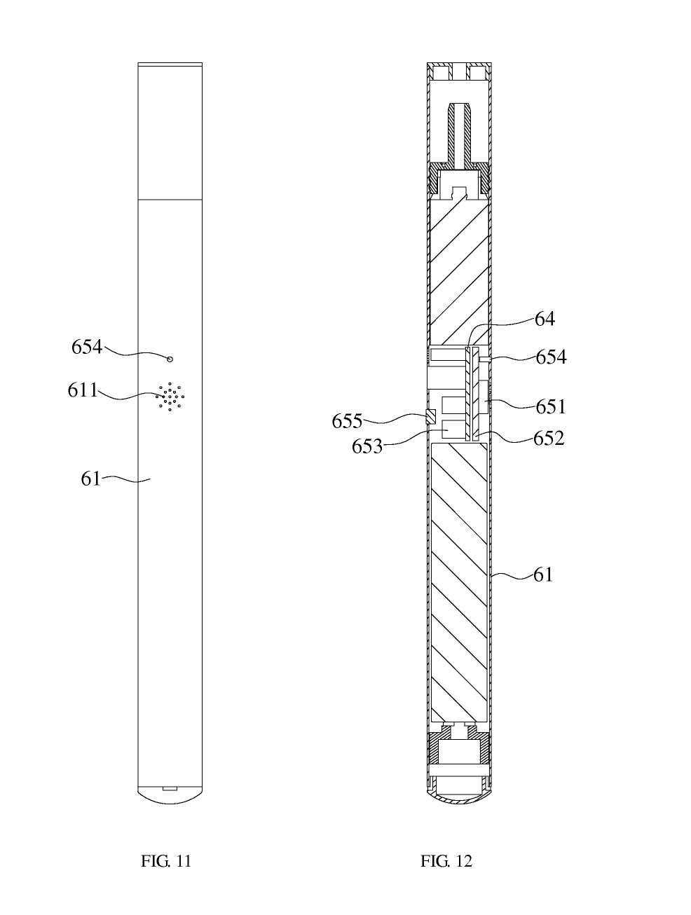

FIG. 11 and FIG. 12 illustrate a detailed structure of the electronic atomization device according to a sixth embodiment of the present invention. The difference between the sixth embodiment and the first embodiment is the authentication device.

The authentication device includes a voice recognition unit and a storage unit 653. The voice recognition unit includes a microphone 651 disposed in the housing and a voice processing circuit 652 for identifying voice signal collected by the microphone 651 and generating voice recognition information. There are provided several through holes 611 formed on the housing 611 corresponding to the microphone 651 for facilitating the propagation of sound waves. The voice processing circuit 652 is electrically connected with the main control circuit 64 so as to transmit the voice recognition information to the main control circuit 64. The storage unit 653 is connected with the main control circuit 64 so as to store the voice recognition information of the user.

The authentication device further includes switch button 655 and an indicator light 654, both of which are disposed on the housing 61. The switch button 655 is electrically connected with the main control circuit 64 for controlling a start or an end of the authentication process. The switch button 655 is disposed at the back of the microphone 651. The main control circuit 64 is electrically connected with the indicator light 654 so as to control the indicator light 654. The indicator light 654 is disposed right above the microphone 651. The indicator light 654 is used as an indication of a state of charge, a state of authentication and a state of use by providing different colors and different flash frequency of light.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. An electronic atomization device, comprising a housing, an atomizer for storing flavor materials and making the flavor materials be atomized and a power supply, both of the power supply and the atomizer being disposed in the housing, wherein further comprises an main control circuit disposed in the housing and an authentication device for receiving and identifying authentication information entered by user, the main control circuit is electrically connected with the power supply and atomizer so as to control the power supply whether to supply power to the atomizer or not, and the authentication device is electrically connected with the main control circuit so as to transmit the authentication information to the main control circuit for identification of user permission.

2. The electronic atomization device according to claim 1, wherein the authentication device comprises an input unit for inputting a password as the authentication information and a storage unit, the input unit is electrically connected with the main control circuit so as to transmit the password entered by the user to the main control circuit, and the storage unit is electrically connected with the main control circuit so as to store the password for being called by the main control unit.

3. The electronic atomization device according to claim 2, wherein the input unit comprises a numeric keyboard disposed on the housing and a keyboard circuit for detecting an input of the numeric keyboard, and the keyboard circuit is electrically connected with the main control circuit so as to transmit the authentication information, entered by the user via the numeric keyboard, to the main control circuit.

4. The electronic atomization device according to claim 3, wherein the input unit further comprises a display screen for outputting a prompt message, and the display screen is disposed on the housing and electrically connected with the main control circuit.

5. The electronic atomization device according to claim 2, wherein the input unit comprises a touch screen disposed on the housing, and the touch screen is electrically connected with the main control circuit for transmitting the authentication information, entered by the user via the touch screen, to the main control circuit.

6. The electronic atomization device according to claim 1, wherein the authentication device comprises a fingerprint reader and a storage unit, the fingerprint reader comprising a fingerprint collecting unit disposed on the housing and a fingerprint identification circuit for identifying a fingerprint collected by the fingerprint collecting unit and then generating a fingerprint information, the fingerprint identification circuit is electrically connected with the main control circuit so as to transmit the fingerprint information to the main control circuit, and the storage unit is connected with the main control circuit so as to store the fingerprint information of the user.

7. The electronic atomization device according to claim 1, wherein the authentication device comprises a face recognition unit and a storage unit, the face recognition unit comprising a camera disposed on the housing and a face identification circuit for identifying a face image collected by the camera and then generating a face recognition information, the face identification circuit is electrically connected with the main control circuit so as to transmit the face recognition information to the main control circuit, and the storage unit is connected with the main control circuit so as to store the face recognition information of the user.

8. The electronic atomization device according to claim 1, wherein the authentication device comprises an iris recognition unit and a storage unit, the iris recognition unit comprising an iris scanner disposed on the housing and an iris identification circuit for identifying an iris image collected by the iris scanner and then generating an iris recognition information, the iris identification circuit is electrically connected with the main control circuit so as to transmit the iris recognition information to the main control circuit, and the storage unit is connected with the main control circuit so as to store the iris recognition information of the user.

9. The electronic atomization device according to claim 1, wherein the authentication device comprises a voice recognition unit and a storage unit, the voice recognition unit comprising a microphone disposed on the housing and a voice processing circuit for identifying a voice signal collected by the microphone and then generating a voice recognition information, the voice processing circuit is electrically connected with the main control circuit so as to transmit the voice recognition information to the main control circuit and the storage unit is connected with the main control circuit so as to store the voice recognition information of the user.

10. The electronic atomization device according to claim 2, wherein the authentication device further comprises a switch button electrically connected with the main control circuit for controlling a start or an end of an authentication process.

11. The electronic atomization device according to claim 2, wherein the authentication device further comprises an indicator light used as an indication of a state of charge, a state of authentication and a state of use, the indicator light is connected with and controlled by the main control circuit.

12. The electronic atomization device according to claim 2, wherein the authentication device further comprises a buzzer disposed in the housing and electrically connected with the main control circuit for giving a warning when failing to authenticate the user.

13. The electronic atomization device according to claim 2, wherein further comprises a network module, which is electrically connected with the main control circuit for building a communication between the electronic atomization device and a network server via network.

14. The electronic atomization device according to claim 2, wherein further comprises a USB interface, which is connected with the main control circuit for charging and transmission of data.

15. The electronic atomization device according to claim 3, wherein further comprises a USB interface, which is connected with the main control circuit for charging and transmission of data.

16. The electronic atomization device according to claim 4, wherein further comprises a USB interface, which is connected with the main control circuit for charging and transmission of data.

17. The electronic atomization device according to claim 5, wherein further comprises a USB interface, which is connected with the main control circuit for charging and transmission of data.

18. The electronic atomization device according to claim 6, wherein further comprises a USB interface, which is connected with the main control circuit for charging and transmission of data.

19. The electronic atomization device according to claim 7, wherein further comprises a USB interface, which is connected with the main control circuit for charging and transmission of data.

20. The electronic atomization device according to claim 8, wherein further comprises a USB interface, which is connected with the main control circuit for charging and transmission of data.
